(19) United States
(12) Patent Application Publication
(10) Pub. No.: US 2006/0267917 A1
(43) Pub. Date: Nov. 30, 2006

(54) System and method for managing an incoming communication

(75) Inventors: Jerzy W. Miernik, Allen, TX (US); Mark R. Nelson, Plano, TX (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/137,077

(22) Filed: May 25, 2005

(51) Int. Cl. G09G 3/36

(52) U.S. Cl. 345/102

(57) ABSTRACT

Managing an incoming communication includes determining an illumination mode of a display. The illumination mode is a normal illumination mode or a low illumination mode. An incoming communication is detected. The display is set in accordance with the determined illumination mode of the display.

### TECHNICAL FIELD OF THE INVENTION

This invention relates generally to the field of communications and more specifically to a system and a method for managing an incoming communication.

### BACKGROUND

The improvement of technology for communication devices has provided devices with many different features. For example, devices may facilitate communication over the Internet and display information about an incoming or outgoing call using a display. The display information may include caller identification, a date and time of the calls, or the number of missed calls. The display on the phone allows a user to obtain several pieces of information before receiving or placing a call. Displays for devices continue to increase in size and functionality.

### SUMMARY OF THE DISCLOSURE

In accordance with the present invention, disadvantages and problems associated with managing an incoming communication in a communication system may be reduced or eliminated.

According to one embodiment of the present invention, managing an incoming communication includes determining an illumination mode of a display. The illumination mode is a normal illumination mode or a low illumination mode. An incoming communication is detected. The display is set in accordance with the determined illumination mode of the display.

Certain embodiments of the invention may provide one or more technical advantages. A technical advantage of one embodiment includes preserving the power of a device while still providing some information to a user regarding an incoming communication. Decreasing the overall brightness of the display preserves the display's power. The display illuminates a limited amount of information to preserve power. Another technical advantage of an embodiment includes extending the life of the display. Decreasing the amount of time that the display operates at full brightness allows the display to operate for a longer period of time before losing illumination ability. Yet another technical advantage of an embodiment includes not disturbing a user because a display has high brightness during an incoming communication. The brightness level of a display may prove bothersome to users if set too high. When the display goes into a power saving mode, the brightness of the display is eliminated and a user may not want the brightness of the display to return to full capacity. For example, a user sleeping may be disturbed if an incoming call is received and the large screen returns to a high brightness level. In one embodiment, the display operates at a lower brightness level but still provides the user with necessary incoming communication information.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates one embodiment of a network incorporating devices with an ability to manage incoming communications;

FIG. 2 illustrates one embodiment of a device with the ability to manage incoming communications;

FIGS. 3A-3E illustrate the device during operation; and

FIG. 4 is a diagram illustrating different states of the device and transitions between the states.

### DETAILED DESCRIPTION OF THE DRAWINGS

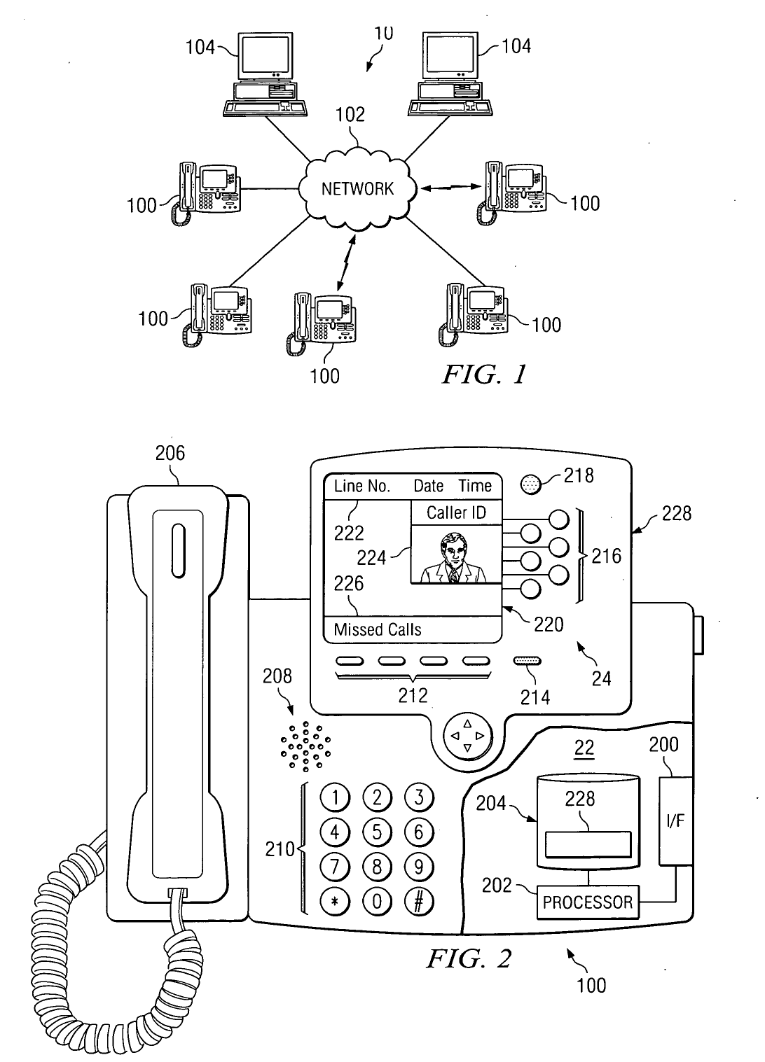

Embodiments of the present invention and its advantages are best understood by referring to FIGS. 1 through 4, like numerals being used for like and corresponding parts of the various drawings.

FIG. 1 illustrates a system 10 that incorporates devices 100 with an ability to manage incoming communications. System 10 includes one or more devices 100 that communicate over one or more networks 102. While communicating over networks 102, devices 100 manage incoming communications based on the mode of devices 100.

According to the illustrated embodiment, system 10 includes devices 100 that communicate with each other through networks 102. Devices 100 manage incoming communication depending on the mode of device 100 that receives the communication. The modes of devices 100 may include a normal illumination mode and a low illumination mode. Devices 100 may send and receive data signals, audio signals, video signals, or any combination of the preceding. The signals may communicate information, such as data, audio, video, multimedia, any suitable type of information, or any combination of the preceding. For example, devices 100 may participate in Internet Protocol (IP) based communication where voice is communicated in packets. The communication may be in the form of a call, a voicemail, an e-mail, or any suitable form of communication. Devices 100 may include, for example, a telephone, an IP telephone, a wireless or cellular telephone, a computer supporting a telephony application, or any other device suitable for communicating. Devices 100 may support, for example, IP, Session Initiation Protocol (SIP), Skinny Control Call Protocol (SCCP), H.323, or any other suitable communication protocol.

Network 102 allows devices 100 to communicate with other networks or devices. Network 102 may include a public switched telephone network (PSTN), a local area network (LAN), a wide area network (WAN), any other public or private data network, a local, regional, or global communication network, an enterprise intranet, other suitable wireline or wireless communication link, or any combination of the preceding. Network 102 may include any combination of gateways, routers, hubs, switches, access points, base stations, and any other hardware, software, or a combination of the preceding that may implement any suitable protocol or communication.

In a particular embodiment, controllers 104 manage devices 100 in system 10. Controllers 104 provide configuration information for devices 100. The configuration information for devices 100 may be changed by controllers 104 to reflect the desired operation of devices 100. Controller 104 may configure device 100 at installation, in response to user actions, or at any suitable time. System 10 may include any suitable number and arrangement of controllers 104 that manage any suitable number and arrangement of devices 100. In an alternative embodiment, devices 100 operate autonomously or independently of other components in system 10 and may not need controllers 104 for configuration.

In operation, devices 100 exchange information and communicate over network 102. Device 100 receives a communication and manages the received communication depending on the state of device 100. Controller 104 provides the configuration information to device 100 to affect how device 100 manages the received communication. For example, if device 100 is operating normally, the received communication will appear in a certain manner on device 100. If device 100 is in another mode, device 100 will manage the received communication accordingly.

Modifications, additions, or omissions may be made to the system without departing from the scope of the invention. For example, devices 100 and controllers 104 may be located at any suitable part of system 10 and coupled in any suitable manner. Moreover, one or more functions performed by controllers 104 or network 102 may be implemented in whole or in part by devices 100. Additionally, system 10 may include any number of devices 100, networks 102, and controllers 104. Any suitable logic comprising software, hardware, other logic, or any suitable combination of the preceding may perform the functions of system 10 and the elements within system 10.

FIG. 2 is a detailed illustration of a device 100 that manages incoming communication. Device 100 includes control components 22 and interfaces 24. Control components 22 direct the operation of device 100. Interfaces 24 receive inputs from a user and/or provide outputs to the user.

Control components 22 include a network interface 200, a processor 202, and a memory 204. Network interface 200 communicates information to and receives information from network 102. Network interface 200 represents any port or connection, real or virtual, including any suitable hardware and/or software that allows device 100 to exchange information with network 102, other devices 100, or other elements of system 10. Processor 202 controls the operation and administration of device 100 by processing information received from network interface 200 and memory 204. Processor 202 includes any hardware, software, or both that operate to control and process information. For example, processor 202 may be a programmable logic device, a microcontroller, microprocessor, any suitable processing device, or any combination of the preceding. Memory 204 stores, either permanently or temporarily, data, operational software, and other information for processing by processor 202. Memory 204 includes any one or a combination of volatile or nonvolatile local or remote devices suitable for storing information. For example, memory 204 may include random access memory (RAM), read only memory (ROM), magnetic storage devices, optical storage devices, or any other suitable information storage device or combination of these devices. Memory 204 includes device parameters 228, which provide specific settings for device 100. Such device parameters 228 may include a display parameter, a brightness parameter, an audio parameter, or any other suitable parameter.

According to the illustrated embodiment, interfaces 24 include components that perform basic communication functions such as placing and receiving a call. Interfaces 24 include such input devices as a keypad 210, setting buttons 212, which allow a user to adjust the settings of device 100, a light sensor 214, and line buttons 216. Input/output devices of interfaces 24 include a handset 206, which includes a speaker and microphone, and a speakerphone 208. Interfaces 24 also include output devices such as an indicator 218, a display 220, and a backlight 228. Light sensor 214 measures the amount of light that light sensor 214 detects. Light sensor 214 includes any combination of hardware or software. The settings of device 100 may adjust according to the amount of light detected by light sensor 214. For example, if light sensor 214 measures a configurable amount of ambient light, device 100 may operate under a default setting. Indicator 218 notifies a user of a communication. For example, indicator 218 may be a light emitting diode (LED) that activates to notify a user of an incoming call, a voice mail message, or any other suitable received communication.

Display 220 receives input from a user and provides output to a user. Display 220 may include any hardware, software, or a combination of the preceding that provides and receives information. In the illustrated embodiment, display 220 includes three lines of information: a first line 222 identifies the line in use, the current date, and the current time; a caller identification 224 identifies the caller using any suitable information such as a telephone number, a name, a picture, or any other suitable information; and a third line 226 identifies the number of missed communications. Display 220 may include additional information or less information and may be configured to present any suitable information using one or more sections of display 220.

In a particular embodiment, backlight 228, located behind display 220, illuminates information on display 220 for the user to view. Backlight 228 may be any suitable light source that brightens display 220. Backlight 228 may illuminate display 220 between a range of brightness levels, where level “0” is no light and level “16” is normal brightness. The intensity of backlight 228 indicates the illumination modes of display 220. The illumination modes represent the different levels of brightness backlight 228 may shine through display 220 to illuminate the information. For example, when backlight 228 is fully on and display 220 is in a normal illumination mode, a user may see all the information on display 220; however, when backlight 228 is completely off and display 220 is in a low illumination mode, display 220 is blank and conveys no information. Display 220 may go into a low illumination mode after device 100 remains inactive for a certain time interval, at a specific time of day, or upon the occurrence of any suitable event. Although backlight 228 is included in a description of a particular embodiment, other display technologies may be used on device 100.

Modifications, additions, or omissions may be made to device 100. For example, display 220 may be a touch screen that displays the information in color. As another example, device 100 may have additional user interfaces. Additionally, any suitable logic comprising software, hardware, other logic, or any suitable combination of the preceding may perform the functions of device 100.

As an example embodiment of operation, backlight 228 ceases to illuminate display 220 of device 100 after a period of inactivity. Upon receiving an incoming communication from another device 100, backlight 228 behind display 220 only illuminates second line 224, which identifies the caller.

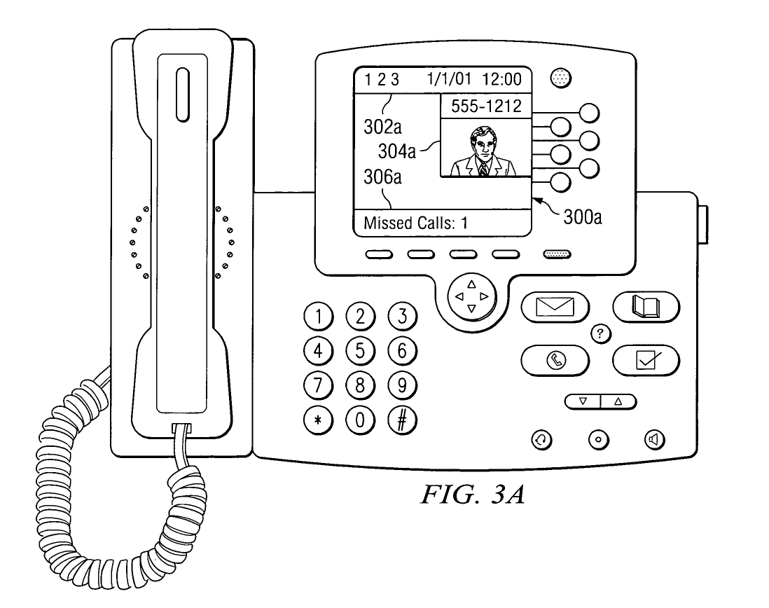

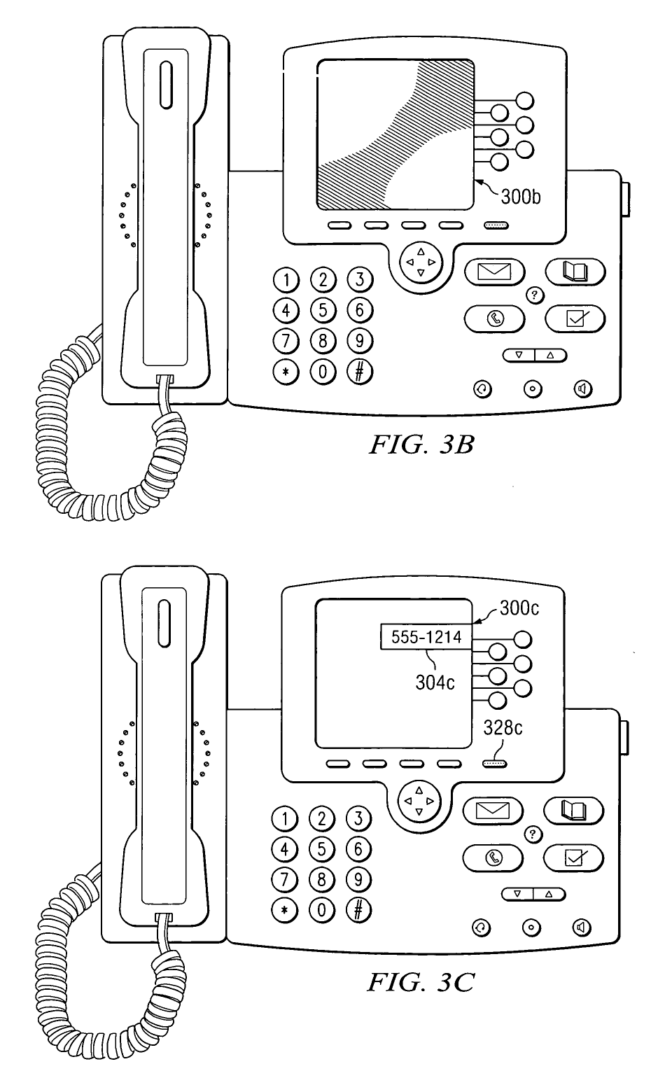

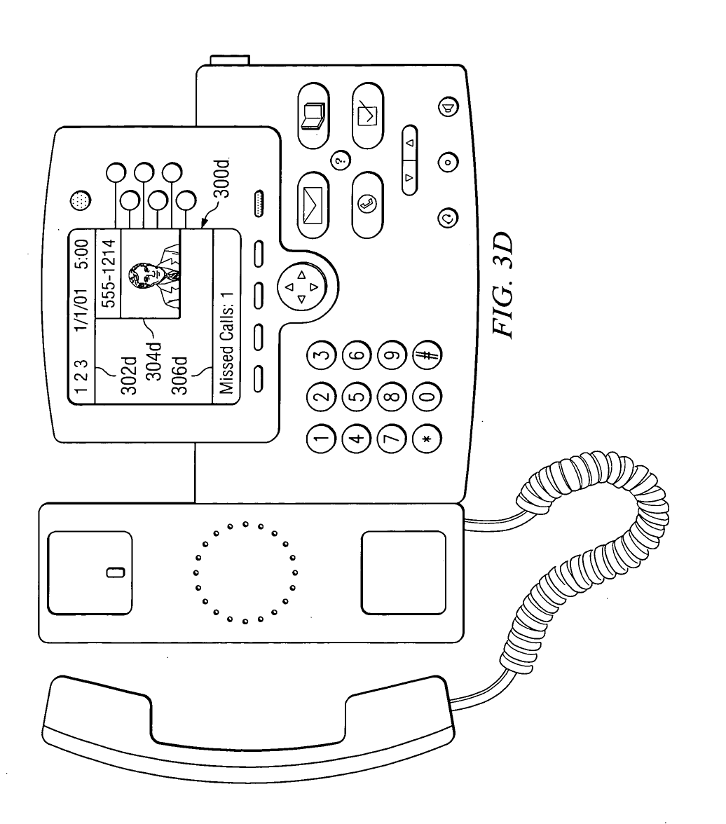

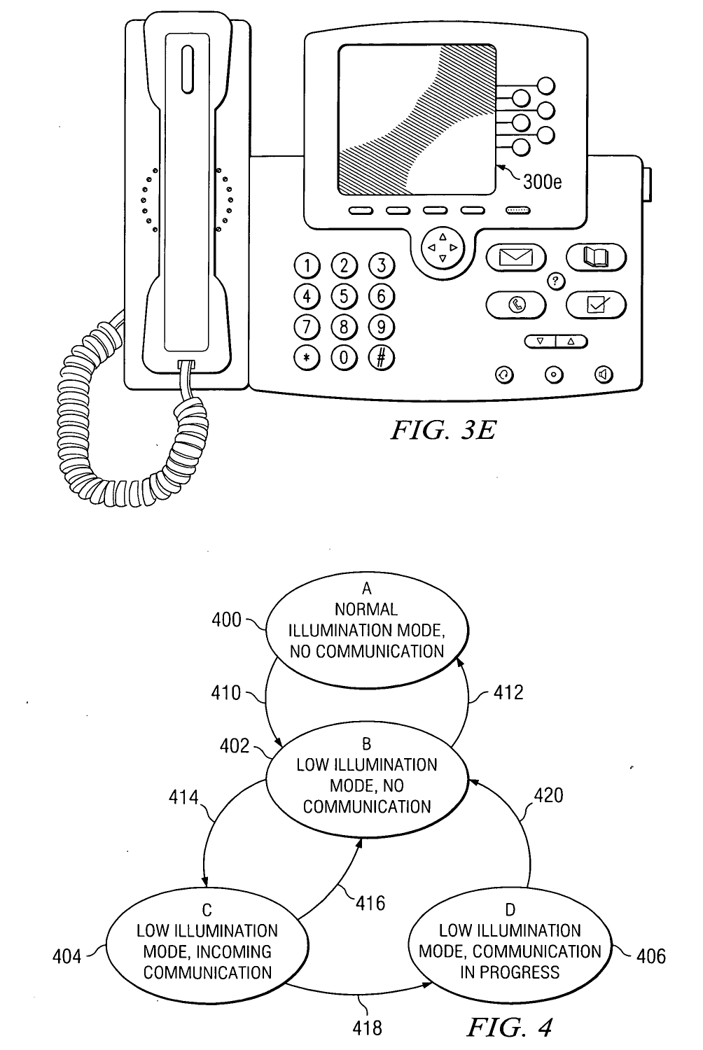

FIGS. 3A through 3E illustrate the various states of device 100 during an example embodiment of operation. Display 300a of device 100 operates in normal illumination mode in FIG. 3A. Upon receiving a call, backlight 228 fully illuminates display 300a and shows first line 302a, caller identification 304a, and third line 306a. After a period of inactivity, backlight 228 discontinues illuminating display 300b, which causes the blank display as shown in FIG. 3B. Display 300b is in low illumination mode because the illumination from backlight 228 ends. Once in low illumination mode, a user may not desire display 300b to return to normal illumination mode if device 100 receives an incoming communication.

In FIG. 3C, device 100 receives an incoming communication that causes device 100 to set device parameters 328c depending on the illumination mode of display 300c. Device parameters 328c indicate the various settings that device 100 may have when receiving an incoming communication. Device parameters 328c may include a display parameter, a brightness parameter, an audio parameter, or any other suitable parameter that provides a setting for device 100. The display parameter indicates how display 300c will appear upon receiving a communication, the brightness parameter indicates the brightness of display 300c upon receiving a communication, and the audio parameter indicates the strength of an incoming communication alert.

If display 300c is in normal illumination mode, the display parameter is set to illuminate all portions of display 300c, the brightness parameter is set to a normal brightness level of 16, and the audio parameter is set to normal strength. An incoming communication will cause the display to completely illuminate at a configurable normal brightness level and alert the user at a configurable normal audio level. In the illustrated embodiment, display 300c receives a communication while in a low illumination mode, so the display parameter is set to illuminate only a specific line in display 300c, the brightness parameter may be set to a brightness level of 1 through 15, and the audio parameter is set to low strength. Display 300c is in low illumination mode and backlight 228 illuminates only a telephone number on caller identification 304c when device 100 receives an incoming communication. The backlight illuminates any specific information on display 300c as configured by controller 104 or a user. The brightness parameter of low illumination mode allows the backlight to be turned on to a low brightness level, but does not allow the backlight to reach the normal brightness level. The brightness parameter may be set to any suitable level as configured by controller 104 or the user. The audio parameter may be configured by controller 104 or the user to a synchronous level of the brightness parameter. For example, when the brightness parameter is set to a low level, the audio parameter is set to low strength. In one embodiment, the audio parameter may operate counter synchronously to the brightness parameter. For example, when the brightness parameter is set to a low level, the audio parameter is set to a normal level. In another embodiment, the brightness parameter is set to brightness level zero, which causes display 300c to remain blank. Instead of illuminating a specific part of display 300c, indicator 218 illuminates when device 100 receives an incoming communication.

In one embodiment, the brightness parameter and audio parameter may also respond to a configurable amount of ambient light that light sensor 214 detects. For example, if light sensor 214 detects a configurable amount of light, device 100 may be configured to set the brightness parameter and audio parameter to a normal level. On the other hand, if light sensor 214 does not detect any light, device 100 may be configured to set the brightness level and audio level to a low level.

In FIG. 3D, the user answers the incoming communication. Display 300d of device 100 illuminates additional components of device 100 at a low level upon the user answering the communication. Now display 300d has first line 300d, caller identification 304d, including the telephone number and a picture, and third line 306d illuminated. In an embodiment, display 306d may be configured to remain in low illumination mode even when the user answers the incoming communication. In another embodiment, the brightness parameter of display 306d may be configured to have a less than normal brightness level and the display parameter may be set to have each line visible to the user.

FIG. 3E depicts device 100 after the user ends the communication. Display 300e immediately reverts to low illumination mode upon the communication ending. Instead of waiting for a period of inactivity to occur or a specified event, display 300e goes into low illumination mode immediately when the communication ends.

Modifications, additions, or omissions may be made to the operation of device 100. For example, when a user answers the incoming communication when device 100 is in a low illumination mode, device 100 may remain in low illumination mode rather than going into normal illumination mode. As another example, display 300c may illuminate any suitable piece of information when an incoming communication is received while device 100 is in low illumination mode. Additionally, any suitable logic comprising software, hardware, other logic, or any suitable combination of the preceding may perform the operation of device 100.

FIG. 4 illustrates a diagram of different states of device 100 and the transitions between the states. State A 400 represents device 100 in normal illumination mode without an incoming communication or a communication in progress. State B 402 represents device 100 in low illumination mode without an incoming communication or a communication in progress. Device 100 transitions between State A 400 and State B 402. Transition 410 from State A 400 to State B 402 may occur if device 100 is inactive for a period of time, if a specified event occurs, in response to configuration by a user, in response to configuration by system 10 (e.g., controller 104), or for any other suitable reason device 100 may need to go into low illumination mode. Transition 412 from State B 402 to State A 400 occurs when device 100 is put into use after it has been in low illumination mode.

State C 404 represents device 100 in low illumination mode with an incoming communication. State D 406 represents device 100 in low illumination mode with a communication in progress. From State C 404, device 100 transitions to State B 402 or State D 406, and device 100 in State B 402 may transition to State C 404. When in State B 402, device 100 transitions to State C 404 when an incoming communication is received through transition 414. During the receipt of the incoming communication, device 100 may transition back to State B 402 through transition 416 or proceed to State D 406 through transition 418. Device 100 returns to State B 402 if the incoming communication is not answered. If the incoming communication is answered, device 100 proceeds to State D 406. From State D 406, the communication eventually ends and device 100 returns to State B 402 through transition 420.

Modifications, additions, or omissions may be made to the states of device 100 and the transitions between the states. For example, a state illustrating an incoming communication and a communication in progress during normal illumination mode may be included.

Certain embodiments of the invention may provide one or more technical advantages. A technical advantage of one embodiment includes preserving the power of a device while still providing some information to a user regarding an incoming communication. Decreasing the overall brightness of the display preserves the display's power. The display illuminates a limited amount of information to preserve power. Another technical advantage of an embodiment includes extending the life of the display. Decreasing the amount of time that the display operates at full brightness allows the display to operate for a longer period of time before losing illumination ability. Yet another technical advantage of an embodiment includes not disturbing a user because a display has high brightness during an incoming communication. The brightness level of a display may prove bothersome to users if set too high. When the display goes into a power saving mode, the brightness of the display is eliminated and a user may not want the brightness of the display to return to full capacity. For example, a user sleeping may be disturbed if an incoming call is received and the large screen returns to a high brightness level. In one embodiment, the display operates at a lower brightness level but still provides the user with necessary incoming communication information.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A method for managing an incoming communication, comprising:
determining an illumination mode of a display, wherein the illumination mode is a normal illumination mode or a low illumination mode;
detecting an incoming communication; and
setting the display in accordance with the determined illumination mode of the display.

2. The method of claim 1, further comprising determining at least one device parameter associated with the determined illumination mode, wherein the device parameters comprise at least one of a display parameter, a brightness parameter, and an audio parameter.

3. The method of claim 1, wherein setting the display in accordance with the determined illumination mode of the display comprises:
illuminating a selected portion of the display in accordance with the determination that the display is in the low illumination mode; and
illuminating the selected portion of the display at a brightness level selected from a range of available brightness levels and associated with the low illumination mode.

4. The method of claim 1, wherein setting the display in accordance with the determined illumination mode of the display comprises:
illuminating the display in accordance with the determination that the display is in the normal illumination mode; and
illuminating the display at a normal brightness level.

5. The method of claim 1, wherein setting the display in accordance with the determined illumination mode of the display comprises setting a brightness parameter to zero in accordance with the determination that the display is in the low illumination mode.

6. The method of claim 5, further comprising illuminating an indicator on a device upon determining that the display is in the low illumination mode.

7. The method of claim 1, further comprising placing a device in the low illumination mode if one of a selected event occurs:
a configured event; and
inactivity for a configured period of time.

8. The method of claim 1, wherein setting the display in accordance with the determined illumination mode of the display comprises setting an audio parameter of a device in accordance with a brightness parameter of the display.

9. The method of claim 8, wherein setting the audio parameter of the device comprises setting the audio parameter to operate counter synchronously to the brightness parameter of the display.

10. The method of claim 1, further comprising adjusting at least one of a selected brightness parameter and display parameter of the display in accordance with an ambient light measurement.

11. The method of claim 1, further comprising adjusting one or more device parameters to the low illumination mode if a non-priority communication is detected.

12. The method of claim 1, further comprising adjusting one or more device parameters to the normal illumination mode if a priority communication is detected.

13. A system for managing an incoming communication, comprising:
a device operable to:
determine an illumination mode of a display, wherein the illumination mode is a normal illumination mode or a low illumination mode;
detect an incoming communication; and
set the display in accordance with the determined illumination mode of the display; and
a controller operable to set device parameters of the device corresponding to the low illumination mode and the normal illumination mode.

14. The system of claim 13, wherein the device is operable to determine at least one device parameter associated with the determined illumination mode, wherein the device parameters comprise at least one of a display parameter, a brightness parameter, and an audio parameter.

15. The system of claim 13, wherein the controller is further operable to:
illuminate a selected portion of the device in accordance with the determination that the display is in the low illumination mode; and
illuminate the selected portion of the device at a brightness level selected from a range of available brightness levels and associated with the low illumination mode.

16. The system of claim 13, wherein the controller is further operable to:
illuminate the display in accordance with the determination that the display is in a normal illumination mode; and
illuminate the display at a normal brightness level.

17. The system of claim 13, wherein the controller is further operable to place the device in the low illumination mode if one of a selected event occurs:
a configured event; and
inactivity for a configured period of time.

18. The system of claim 13, wherein the controller is further operable to set an audio parameter of the device in accordance with a brightness parameter of the display.

19. The system of claim 13, wherein the controller is further operable to adjust at least one of a selected brightness parameter and display parameter of the display in accordance with an ambient light measurement.

20. The system of claim 13, wherein the controller is further operable to adjust one or more device parameters to the low illumination mode if a non-priority communication is detected.

21. A device, comprising:
a display operable to display information;
an interface operable to communicate with a network;
a memory operable to store at least one device parameter; and
a processor coupled to the interface, the memory, and the display, the processor operable to determine an illumination mode of the display, wherein the illumination mode is a normal illumination mode or a low illumination mode, the processor further operable to set the display in accordance with determined illumination mode of the display.

22. The device of claim 21, wherein the interface is further operable to communicate packets encoding voice information.

23. The device of claim 21, wherein the processor is further operable to determine at least one device parameter associated with the determined illumination mode, wherein the device parameters comprise at least one of a display parameter, a brightness parameter, and an audio parameter.

24. The device of claim 21, further comprising a caller identification operable to illuminate in accordance with the determination that the display is in the low illumination mode, the caller identification operable to illuminate at a brightness level selected from a range of available brightness levels and associated with the low illumination mode.

25. The device of claim 21, wherein the display is further operable to illuminate at a normal brightness level in accordance with the determination that the display is in a normal illumination mode.

26. The device of claim 21, further comprising an indicator operable to illuminate upon the processor determining that the display is in the low illumination mode and the brightness parameter is set to zero.

27. The device of claim 21, wherein the processor is further operable to place the device in the low illumination mode if one of a selected event occurs:
a configured event; and
inactivity for a configured period of time.

28. The device of claim 21, wherein the processor is further operable to set an audio parameter of the device in accordance with a brightness parameter of the display.

29. The device of claim 21, further comprising a light sensor operable to measure ambient light, the processor further operable to adjust at least one of a selected brightness parameter and display parameter of the display in accordance with the ambient light measurement.

30. The device of claim 21, wherein the processor is further operable to adjust one or more device parameters to the low illumination mode if a non-priority communication is detected.

31. The device of claim 21, further comprising:
a speaker operable to output voice information; and
a microphone operable to receive voice input information.

32. The device of claim 31, further comprising a handset comprising the speaker and the microphone operable to receive voice input information and output voice information.

33. A computer readable medium including logic for managing an incoming communication, the logic operable to perform the following steps:
determine an illumination mode of a display, wherein the illumination mode is a normal illumination mode or a low illumination mode;
detect an incoming communication; and
set the display in accordance with the determined illumination mode of the display.

34. The computer readable medium of claim 33, the logic further operable to determine at least one device parameter associated with the determined illumination mode, wherein the device parameters comprise at least one of a display parameter, a brightness parameter, and an audio parameter.

35. The computer readable medium of claim 33, the logic further operable to:
illuminate a selected portion of the display in accordance with the determination that the display is in the low illumination mode; and
illuminate the selected portion of the display at a brightness level selected from a range of available brightness levels and associated with the low illumination mode.

36. The computer readable medium of claim 33, the logic further operable to:
illuminate the display in accordance with the determination that the display is in the normal illumination mode; and
illuminate the display at a normal brightness level.

37. The computer readable medium of claim 33, the logic further operable to set a brightness parameter to zero in accordance with the determination that the display is in the low illumination mode.

38. The computer readable medium of claim 33, the logic further operable to illuminate an indicator on a device upon determining that the display is in the low illumination mode.

39. The computer readable medium of claim 33, the logic further operable to place a device in the low illumination mode if one of a selected event occurs:
a configured event; and
inactivity for a configured period of time.

40. The computer readable medium of claim 33, the logic further operable to set an audio parameter of a device in accordance with a brightness parameter of the display.

41. The computer readable medium of claim 40, the logic further operable to set the audio parameter to operate counter synchronously to the brightness parameter of the display.

42. The computer readable medium of claim 33, the logic further operable to adjust at least one of a selected brightness parameter and display parameter of the display in accordance with an ambient light measurement.

43. The computer readable medium of claim 33, the logic further operable to adjust one or more device parameters to the low illumination mode if a non-priority communication is detected.

44. The computer readable medium of claim 33, the logic further operable to adjust one or more device parameters to the normal illumination mode if a priority communication is detected.

45. A system for managing an incoming communication, comprising:
means for determining an illumination mode of a display, wherein the illumination mode is a normal illumination mode or a low illumination mode;
means for detecting an incoming communication; and
means for setting the display in accordance with the determined illumination mode of the display.

46. A method for managing an incoming communication, comprising:
determining an illumination mode of a display, wherein the illumination mode is a normal illumination mode or a low illumination mode;
detecting an incoming communication;
setting the display and an audio parameter in accordance with the determined illumination mode of the display, wherein setting the display in accordance with the determined illumination mode of the display comprises at least one of the following steps:
illuminating a selected portion of the display in accordance with the determination that the display is in the low illumination mode; and illuminating the selected portion of the display at a brightness level selected from a range of available brightness levels and associated with the low illumination mode;
illuminating the display in accordance with the determination that the display is in the normal illumination mode; and illuminating the display at a normal brightness level; and
setting a brightness parameter to zero in accordance with the determination that the display is in the low illumination mode; and illuminating an indicator on a device upon determining that the display is in the low illumination mode; and
determining at least one device parameter associated with the determined illumination mode, wherein the device parameters comprise at least one of a display parameter, a brightness parameter, and an audio parameter.

47. The method of claim 46, further comprising adjusting at least one of a selected brightness parameter and display parameter of the display in accordance with an ambient light measurement.

48. The method of claim 46, further comprising adjusting one or more device parameters to the normal illumination mode if a priority communication is detected.
